(19) United States
(12) Patent Application Publication
(10) Pub. No.: US 2017/0080683 A1
(43) Pub. Date: Mar. 23, 2017

(54) LAMINATED WATERPROOF TEXTILE PRODUCT

(71) Applicant: Standard Fiber, LLC, Burlingame, CA (US)

(72) Inventors: Russ Holbrook, Matthews, NC (US); Chun Leung Chan, San Francisco, CA (US)

(21) Appl. No.: 14/860,861

(22) Filed: Sep. 22, 2015

(51) Int. Cl. B32B 7/08; B32B 27/40

(52) U.S. Cl. CPC B32B 7/08; B32B 27/40; B32B 2317/10; B32B 2307/73; B32B 2601/00

(57) ABSTRACT

A waterproof textile product includes four layers. A first layer is an outer layer, a fill layer is adjacent to the outer layer. An intermediate layer is adjacent the fill layer and a waterproof material is laminated to the intermediate layer. The outer layer, fill layer and intermediate layer are joined to one another by a quilting structure with the waterproof layer laminated to the intermediate layer. The product can be a mattress, a mattress pad, a mattress cover, a mattress jacket, a seat cushion, a seat cushion cover, or a sofa cover.

### BACKGROUND

Current waterproof domestic textile products, such as mattresses, mattress covers, mattress jackets, seat cushions, seat cushion covers, sofa covers and the like, have a top layer with a waterproofing structure that includes five layers. One known structure, as shown in FIG. 1, includes three upper layers that are quilting layers, that are constructed having, in sequence, a first cloth layer 1, a cotton-lined layer 2, and a second cloth layer 3, and two lower layers that are, in sequence, a base cloth layer 4 and a TPU (thermoplastic polyurethane, thermoplastic polyurethane elastomer rubber) coated film layer 5. The TPU-coated film layer 5 on the base cloth layer 4 and the quilting layers are fixed peripherally by sewing, overlock-stitching, or serging.

One drawback to these structures and processes to make these structure is that they are relatively complicated, large amount of materials are needed to fabricate the structures, and as such, considerable time is required for fabrication or production of these structures.

Moreover, many such waterproof products, for example, waterproof mattress pads have a non-quilted separate layer of water proof material in the back of the mattress pad. The waterproof material is not secured to the back of the pad. As such, the waterproof layer of fabric and the back of the mattress pad can readily separate. This is particularly problematic when washing the product in that the fabric can tangle during washing and drying cycles. Separation of the waterproof layer can adversely impact the integrity and longevity of waterproof layer. Furthermore, the waterproof layer can be very noisy.

Accordingly, there is a need for a waterproof textile product that is less cumbersome in structure and can be manufactured with lesser amounts of materials and in shorter manufacturing or production times. More desirably, such a structure stands up well after repeated washing and drying cycles, maintaining its structure and waterproof characteristics. Still more desirably, such a product creates less noise in use than known waterproof products.

### SUMMARY

A waterproof textile product includes four layers. A first layer is an outer layer. A fill layer is adjacent the outer layer. An intermediate layer is adjacent the fill layer and a waterproof material is laminated to the intermediate layer. The outer layer, fill layer and intermediate layer are joined to one another with the waterproof layer laminated to the intermediate layer. In a present embodiment, the waterproof material is completely adhered to and coextensive with the intermediate layer.

The outer layer, fill layer and intermediate layer are joined to one another by, for example, peripheral stitching and a quilting structure. The waterproof layer can be a polyurethane, such as a thermoplastic polyurethane.

The outer layer can be a cloth material, such as cotton or cotton blend. The intermediate layer can be a cloth layer, such as cotton or cotton blend that is compatible with the waterproof material that is laminated thereto.

The fill material can be cotton, lined cotton, woven materials, nonwoven materials, feathers, down, sponge or combinations thereof. The product can be fabricated as a mattress, a mattress pad, a mattress cover, a mattress jacket, a seat cushion, a seat cushion cover, or a sofa cover.

A waterproof textile product cover for a seat cushion cover or sofa includes four layers, a first layer being an outer layer, a fill layer adjacent the outer layer an intermediate layer adjacent the fill layer and a waterproof material laminated to the intermediate layer. The waterproof material is completely adhered to and coextensive with the intermediate layer. The outer layer, fill layer and intermediate layer are joined to one another by peripheral stitching and a quilting structure. The waterproof layer is laminated to the intermediate layer.

The waterproof layer can be laminated to the intermediate layer prior to the affixing the outer layer, fill layer and intermediate layer to one another, or the waterproof layer can be laminated to the intermediate layer after the outer layer, fill layer and intermediate layer are affixed to one another.

The present waterproof textile product and cover exhibit advantages over known products by directly laminating the waterproofing material with the intermediate layer, omitting a base cloth layer. Such a structure is fabricated using a process in which the coated film or waterproof layer and the quilting layers are fixed to one another by peripheral stitching and a quilting structure.

These and other features and advantages of the present invention will be readily apparent from the following detailed description, in conjunction with the claims.

### BRIEF DESCRIPTION OF DRAWINGS

The benefits and advantages of the present invention will become more readily apparent to those of ordinary skill in the relevant art after reviewing the following detailed description and accompanying drawings, wherein:

FIG. 1 a structural schematic diagram of the top waterproofing structure of a prior art domestic textile product;

FIG. 2 is a structural schematic diagram of an embodiment of a laminated textile product with waterproofing structure; and

FIGS. 3A and 3B are constructed and deconstructed cross-sectional illustrations of an embodiment of the laminated waterproof textile product.

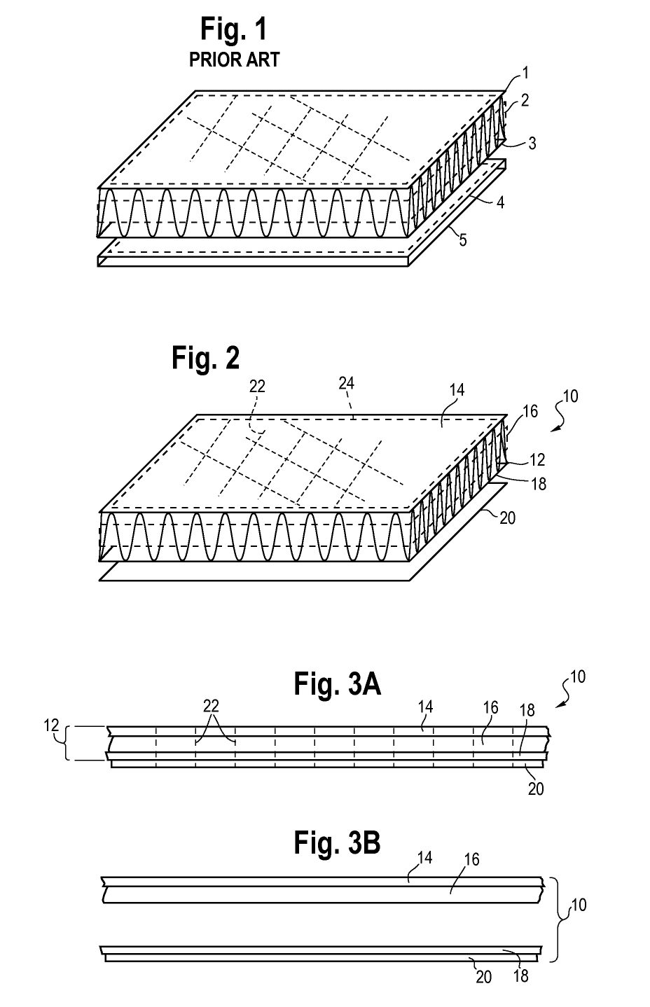

### DETAILED DESCRIPTION

While the present device is susceptible of embodiment in various forms, there is shown in the drawings and will hereinafter be described one or more presently preferred embodiments with the understanding that the present disclosure is to be considered an exemplification of the device and is not intended to limit the disclosure to the specific embodiment or embodiments illustrated.

An embodiment of a laminated waterproof textile product 10 is illustrated in FIGS. 2 and 3A-B. The textile product 10 is formed from four layers. The upper three layers 12 are, in sequence, an outer layer 14, a filling material layer or fill 16, and an intermediate layer 18. A layer of waterproof material (a waterproof or lower layer 20) is laminated with or to the intermediate layer 18. In a present embodiment, the waterproof material layer 20 is fully adhered to and coextensive with the intermediate layer 18. In a present construction, the upper layers, that is the upper 14, fill 16 and intermediate layers 18 are attached or affixed to one another by a quilting seam structure, as illustrated at 22. The construction can also include peripheral stitching, as illustrated at 24, instead of, or in addition to the quilting structure 22.

The waterproof layer 20 can be formed from polyurethane, polyvinyl chloride, polyethylene, or a variety of other waterproofing materials that can be formed into thin sheets. In an embodiment, the waterproof layer 20 is a thermoplastic polyurethane, thermoplastic polyurethane elastomer rubber (TPU) that is coated onto the intermediate layer. In an embodiment, the waterproof layer 20 is laminated to the intermediate layer 18 by, for example, heat sealing, adhesive, extrusion directly on to the intermediate layer or the like. In such a construction, the waterproof layer 20 cannot be separated from intermediate layer 18.

The waterproof layer 20 can be laminated to the intermediate layer 18 prior to the affixing the outer layer 14, fill layer 16 and intermediate layer 18 to one another, or the waterproof layer 20 can be laminated to the intermediate layer 18 after the outer layer 14, fill layer 16 and intermediate layer 18 are affixed to one another.

In an embodiment, the outer layer 14 is cloth layer. The cloth can be, for example, cotton, a cotton blend, a synthetic material such as polyester, wool or blends of any of these materials. The intermediate layer 18 can likewise be a cloth layer and can be, for example, cotton, a cotton blend, a synthetic material such as polyester, wool or blends of any of these materials. The intermediate layer 18 can be the same as the outer layer 14 or it can be fabricated from a different material. The intermediate layer 18 should, however, be compatible with the waterproof layer material 20 and the method or methods and characteristics of the coating/laminating process that is used to laminate the waterproof layer 20 to the intermediate layer 18.

The filling material layer or filler 16 can be formed from a variety of materials, such as cotton, lined cotton, other woven materials, nonwoven materials, feathers, down, sponge, and the like. The patterns of the quilting structure 22 can also be any of various patterns suitable for machine quilting, such as a diamond shape quilting, grid shape quilting, or a strip or box quilting.

In a present embodiment, the waterproof layer 20 is sufficiently thick to maintain integrity during use, machine washing and drying cycles and the like. The layer 20 is, however, also sufficiently thin so as to promote comfort. In addition, because the waterproof layer 20 is laminated (affixed or adhered to) to the intermediate layer 18, it has also been found to be a “quiet” layer—that is, movement and jostling of the textile product 10 does not result in loud or crinkling noises. Thus, physical comfort, as well as low audible noise levels are maintained.

The directional references of top, bottom, upper, lower and side are provided for reference only and are not intended to limit the disclosure in any way.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A waterproof textile product, comprising:
four layers, a first layer being an outer layer, a fill layer adjacent the outer layer an intermediate layer adjacent the fill layer and a waterproof material laminated to the intermediate layer, wherein the outer layer, fill layer and intermediate layer are joined to one another with the waterproof layer laminated to the intermediate layer.

2. The waterproof textile product of claim 1 wherein the waterproof material is completely adhered to and coextensive with the intermediate layer.

3. The waterproof textile product of claim 1, wherein the outer layer, fill layer and intermediate layer are joined to one another by a quilting structure.

4. The waterproof textile product of claim 1, wherein the outer layer, fill layer and intermediate layer are joined to one another by peripheral stitching.

5. The waterproof textile product of claim 1, wherein the waterproof layer is a polyurethane.

6. The waterproof textile product of claim 5, wherein the waterproof layer is a thermoplastic polyurethane.

7. The waterproof textile product of claim 1, wherein the outer layer is a cloth material.

8. The waterproof textile product of claim 7 wherein the cloth material is a cotton or cotton blend.

9. The waterproof textile product of claim 1, wherein the intermediate layer is a cloth layer compatible with the waterproof material laminated thereto.

10. The waterproof textile product of claim 9 wherein the cloth material is a cotton or cotton blend.

11. The waterproof textile product of claim 1 wherein the fill material is one or a combination of cotton, lined cotton, woven materials, nonwoven materials, feathers, down and sponge.

12. The waterproof textile product of claim 1 wherein the product is a mattress, a mattress pad, a mattress cover, a mattress jacket, a seat cushion, a seat cushion cover, or a sofa cover.

13. A waterproof textile product cover for a seat cushion cover or sofa, comprising:
four layers, a first layer being an outer layer, a fill layer adjacent the outer layer an intermediate layer adjacent the fill layer and a waterproof material laminated to the intermediate layer, waterproof material being completely adhered to and coextensive with the intermediate layer, wherein the outer layer, fill layer and intermediate layer are joined to one another by peripheral stitching and a quilting structure, and wherein the waterproof layer is laminated to the intermediate layer.

14. The waterproof textile product cover of claim 13, wherein the waterproof layer is a polyurethane.

15. The waterproof textile product cover of claim 14, wherein the waterproof layer is a thermoplastic polyurethane.

16. The waterproof textile product cover of claim 13, wherein the outer layer is a cloth material.

17. The waterproof textile product cover of claim 16 wherein the cloth material is a cotton or cotton blend.

18. The waterproof textile product cover of claim 13, wherein the intermediate layer is a cloth layer compatible with the waterproof material laminated thereto.

19. The waterproof textile product cover of claim 18 wherein the cloth material is a cotton or cotton blend.

20. The waterproof textile product cover of claim 13 wherein the fill material is one or a combination of cotton, lined cotton, woven materials, nonwoven materials, feathers, down and sponge.
